(19) United States
(12) Patent Application Publication
(10) Pub. No.: US 2018/0011369 A1
(43) Pub. Date: Jan. 11, 2018

(54) DISPLAY DEVICE HAVING A CONNECTION MEMBER SECURED IN PLACE BY A CONDUCTIVE LAYER

(71) Applicant: SAMSUNG DISPLAY CO., LTD., Yongin-si (KR)

(72) Inventors: Cheol Geun AN, Yongin-si (KR); Jong Hyuk LEE, Seoul (KR); Chung-Seok LEE, Hwaseong-si (KR); Eui Yun JANG, Seoul (KR); Jeong Ho Hwang, Cheonan-si (KR)

(21) Appl. No.: 15/613,415

(22) Filed: Jun. 5, 2017

(30) Foreign Application Priority Data
Jul. 5, 2016 (KR) 10-2016-0084910

(51) Int. Cl. G02F 1/1333; G06F 3/14; G02B 5/30; G02F 1/167; G09G 3/20; G09F 9/30

(52) U.S. Cl. CPC G02F 1/133348; G09G 3/20; G09F 9/301; G09F 9/30; G02B 5/305; G02F 1/167; G02B 5/3083; G06F 3/14

(57) ABSTRACT

A display device includes a pad portion disposed on a first substrate, a connection member disposed on the pad portion, and an anisotropic conductive layer disposed between the pad portion and the connection member, the anisotropic conductive layer including conductive particles. The pad portion includes a pad, the pad including a first pad electrode and a second pad electrode. A first insulating layer is disposed between the first pad electrode and the second pad electrode. The first insulating layer overlaps the first pad electrode. The second pad electrode is connected to the first pad electrode through a first contact hole. The first contact hole overlaps a center of the first pad electrode. The first pad electrode is at least twice as wide as the first contact hole.

### CROSS-REFERENCE TO RELATED APPLICATION

This application claims priority under 35 U.S.C. §119 to Korean Patent Application No. 10-2016-0084910, filed in the Korean Intellectual Property Office on Jul. 5, 2016, the disclosure of which is incorporated by reference herein in its entirety.

### TECHNICAL FIELD

This present invention relates to a display device. More particularly, the present invention relates to a display device having a connection member secured in place by a conductive layer.

### DISCUSSION OF THE RELATED ART

Display devices such as an organic light emitting device and a liquid crystal display include a display panel, in which pixels for displaying an image may be disposed. A pad portion for inputting or outputting signals, controlling an operation of the display panel, may be included in the display panel. A connection member such as an integrated circuit chip (IC chip) or a film type of flexible printed circuit board (FPCB) may be bonded to the pad portion.

An anisotropic conductive layer (ACF) may be used to electrically connect the connection member and the pad portion. The anisotropic conductive layer may be electrically conductive.

The anisotropic conductive layer may include conductive particles disposed in a resin, and the conductive particles may be disposed between the connection member and the pad portion to electrically connect the connection member with the pad portion. However, due to the shape of the connection member and the pad portion, some of the conductive particles might not contact both the connection member and the pad portion.

Pressure may be applied to the anisotropic conductive layer to cause the conductive particles to contact both the connection member and the pad portion. In this case, the conductive particles may flow in the resin, and may reduce an insulation property of the anisotropic conductive layer.

### SUMMARY

According to an exemplary embodiment of the present invention, a display device includes a pad portion disposed on a first substrate, a connection member disposed on the pad portion, and an anisotropic conductive layer disposed between the pad portion and the connection member, the anisotropic conductive layer including conductive particles. The pad portion includes a pad, the pad including a first pad electrode and a second pad electrode, wherein a first insulating layer is disposed between the first pad electrode and the second pad electrode. The first insulating layer overlaps the first pad electrode, wherein the second pad electrode is connected to the first pad electrode through a first contact hole. The first contact hole overlaps a center of the first pad electrode, and wherein the first pad electrode is at least twice as wide as the first contact hole.

According to an exemplary embodiment of the present invention, a display device includes a pad portion disposed on a first substrate, a connection member disposed on the pad portion, and an anisotropic conductive layer disposed between the pad portion and the connection member, wherein the anisotropic conductive layer includes conductive particles. The pad portion includes a pad, the pad including a first pad electrode and a second pad electrode, and a first insulating layer is disposed between the first pad electrode and the second pad electrode. The first insulating layer overlaps the first pad electrode, and the second pad electrode is connected to the first pad electrode through a first contact hole. A surface of the second pad electrode includes a first portion and a second portion that are respectively disposed at opposite sides of the first contact hole in a width direction of the pad. The first and second portions of the surface of the second pad electrode are substantially coplanar. A gap between the first portion and the second portion of the surface of the second pad electrode is smaller than a diameter of the conductive particles.

According to an exemplary embodiment of the present invention, a mounted integrated circuit device includes a pad portion disposed on a first substrate, an integrated circuit disposed on the pad portion, and an anisotropic conductive layer disposed between the pad portion and the integrated circuit, the anisotropic conductive layer including a first conductive particle and a second conductive particle. The pad portion includes a pad, wherein the pad includes a first pad electrode and a second pad electrode overlapping the first pad electrode, and a first insulating layer is disposed between the first pad electrode and the second pad electrode, wherein the first pad electrode includes a first surface portion and a second surface portion substantially coplanar with the first surface portion on a first plane, the first and second surface portions of the first pad electrode being separated from each other along the first plane. The first insulating layer overlaps the first pad electrode, and the second pad electrode is connected to the first pad electrode through a first contact hole. The first contact hole overlaps a center of the first pad electrode. The first pad electrode is at least twice as wide as the first contact hole. The first conductive particle directly contacts the first surface portion of the first pad electrode, the second conductive particle directly contacts the second surface portion of the first pad electrode. A gap between the first and second surface portions of the first pad electrode, measured in a same direction as a direction in which the width of the first contact hole is measured, is smaller than the width of the first contact hole.

### BRIEF DESCRIPTION OF THE DRAWINGS

The above and other features of the present invention will become more apparent by describing in detail exemplary embodiments thereof with reference to the accompanying drawings, in which:

FIG. 1 is a top plan view illustrating a display device according to an exemplary embodiment of the present invention;

FIG. 2 is a top plan view illustrating a pad of the display device of FIG. 1, according to au exemplary embodiment of the present invention;

FIG. 3 is a cross-sectional view of a pad region of the display device of FIG. 1, according to an exemplary embodiment of the present invention;

FIG. 4 is a cross-sectional view illustrating a pad region according to an approach;

FIG. 5 is a top plan view illustrating a pad of the display device of in FIG. 1, according to an exemplary embodiment of the present invention;

FIG. 6 is a cross-sectional view illustrating a pixel area of the display device of in FIG. 1, according to an exemplary embodiment of the present invention;

FIG. 7 is a cross-sectional view illustrating a pixel area of the display device of in FIG. 1, according to an exemplary embodiment of the present invention;

FIG. 8 is a cross-sectional view illustrating a conductive particle according to an exemplary embodiment of the present invention;

FIG. 9 is a cross-sectional view illustrating an anisotropic conductive layer of a display device, according to an exemplary embodiment of the present invention;

FIG. 10 is a perspective view illustrating a state in which an anisotropic conductive layer is applied to a pad portion of a display device, according to an exemplary embodiment of the present invention; and

FIG. 11 is a perspective view illustrating a state in which an anisotropic conductive layer and an integrated circuit chip are applied to a pad portion of a display device, according to an exemplary embodiment of the present invention.

### DETAILED DESCRIPTION OF THE EMBODIMENTS

The present invention will be described more fully hereinafter with reference to the accompanying drawings. The described embodiments may be modified in various different ways without departing from the spirit and scope of the present invention.

Like reference numerals may refer to like elements throughout the specification.

In the drawings, the sizes and thicknesses of elements and/or regions may be exaggerated for clarity.

It will be understood that when an element such as a layer, film, region, or substrate is referred to as being “on” another element, it can be directly on the other element or intervening elements may also be present therebetween.

A display device, according to an exemplary embodiment of the present invention, will now be described in detail.

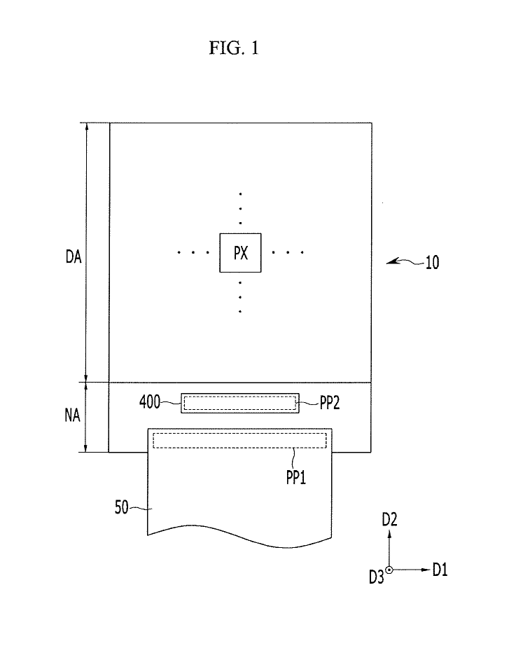

FIG. 1 is a top plan view illustrating a display device according to an exemplary embodiment of the present invention.

Referring to FIG. 1, a display device includes a display panel 10 and a flexible printed circuit board 50 connected to the display panel 10.

The display panel 10 includes a display area (DA) for displaying an image, and a non-display area (NA) disposed at a border of the display area (DA). Elements and wires for generating and/or transmitting various signals applied to the display area (DA) and/or other wiring may be disposed in the non-display area (NA). In FIG. 1, although the non-display area (NA) is shown to be disposed adjacent to only one border edge (e.g., a lower region) of the display panel 10, it is understood that the non-display area (NA) may also be disposed adjacent to a plurality of border edges (e.g., left and right edges and/or an upper edge) of the display panel 10. The display area (DA) is shown to be quadrangular. However, the display area (DA) may also be polygonal, circular, oval, elliptical, or curved.

Pixels PX are disposed, for example, in a matrix in the display area (DA) of the display panel 10. Further, signal lines such as gate lines, data lines, and the like, may be disposed in the display area (DA). The gate lines may extend in a first direction D1 (e.g., a row direction), and the data lines may extend in a second direction D2 (e.g., a column direction) crossing the first direction D1. Each pixel PX may be connected to a gate line and a data line to receive a gate signal and a data signal. In the case of an organic light emitting device, driving voltage lines, which may extend, for example, in the second direction D2, to transmit a driving voltage to the pixels PX, may be disposed in the display area (DA).

A pad portion PP1 for receiving an external signal may be disposed in the non-display area (NA) of the display panel 10. A first end of the flexible PCB 50 may be connected to the pad portion PP1. An anisotropic conductive layer may be disposed between the pad portion PP1 and the flexible PCB 50. A second end of the flexible PCB 50 may be connected, for example, to an external PCB to transmit signals such as an image data signals or control signals thereto.

A driver for generating and/or processing various signals for driving the display panel 10 may be disposed in the non-display area (NA) of the display panel 10, the flexible PCB 50, or the external PCB. The driver may include a data driver for applying a data signal to the data line, a gate driver for applying a gate signal to the gate line, and a signal controller for controlling the data driver and the gate driver.

As shown in FIG. 1, the data driver is included in an integrated circuit chip 400. The integrated circuit chip 400 may be mounted on a pad portion PP2. The pad portion PP2 may be disposed between the display area (DA) and the pad portion PP1. An anisotropic conductive layer may be disposed between the pad portion PP2 and the integrated circuit chip 400. In addition, the data driver may be mounted on the flexible PCB 50 as an integrated circuit chip. The integrated circuit chip may be connected to the pad portion PP1 through a tape carrier package (TCP). The gate driver may be disposed in the non-display area NA as, for example, an integrated circuit chip. In this case, the non-display area NA may be located, for example, along the border of the display panel 10. The signal controller may be included in the integrated circuit chip 400, or the signal controller may be provided as a separate integrated circuit chip.

The integrated circuit chip 400 and the pad portion PP2 will be described in detail above according to one or more exemplary embodiments of the present invention.

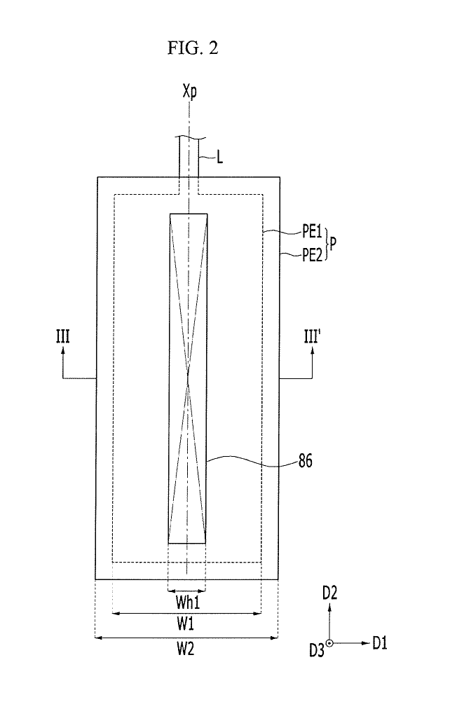

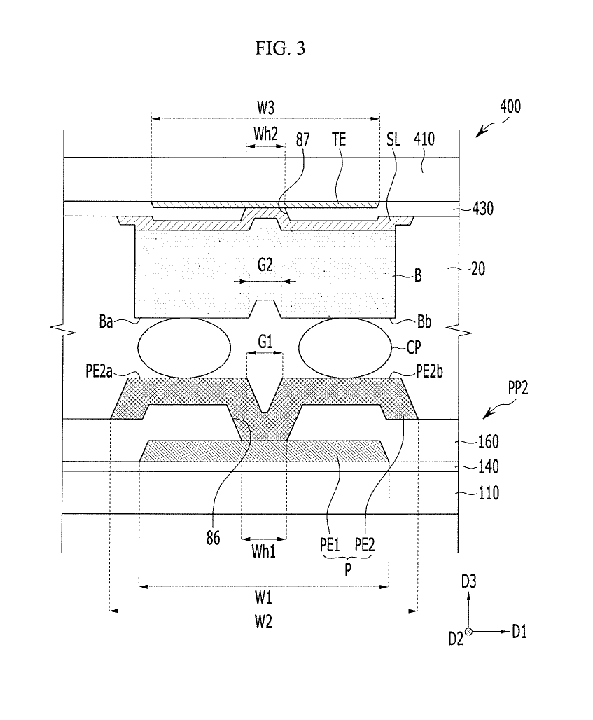

FIG. 2 is a top plan view illustrating a pad of the display device of FIG. 1, according to an exemplary embodiment of the present invention. FIG. 3 is a cross-sectional view of a pad region of the display device of FIG. 1, according to an exemplary embodiment of the present invention.

FIG. 2 illustrates a pad P of a plurality of pads P included in the pad portion PP2 of the display panel 10 of FIG. 1. The pads P of the pad portion PP2 may be arranged, for example, along the first direction D1 at predetermined intervals. In addition, the pads P may be arranged in a single row or in a plurality of rows. FIG. 3 illustrates a cross-sectional view of the display device of FIG. 1, taken along line III-III′ of FIG. 2, in which the integrated circuit chip 400 is bonded on the pad portion PP2.

Referring to FIG. 2, the pad P may be formed to have an overall rectangular planar shape. The pad P may have long sides (lengths) and short sides (widths), and a direction of the long sides may be substantially parallel to the second direction D2. In addition, the pad P may be formed to have other planar shapes such as a general parallelogram or a polygon, and the long side direction of the pad P may be inclined with respect to the second direction D2. The lengths of the long and short sides of the pad P may be substantially the same. However, it is understood that the pad may be modified to have various planar shapes.

Referring to FIG. 2 and FIG. 3, along with FIG. 1, the pad P of the pad portion PP2 is disposed on a substrate 110 of the display panel 10. The pad P includes a first pad electrode PE1 and a second pad electrode PE2. The integrated circuit chip 400 includes a substrate 410 and a bump B protruding downwardly from the substrate 410. An anisotropic conductive layer 20, including conductive particles CP, may be disposed between the pad portion PP2 and the integrated circuit chip 400, and at least one conductive particle CP is disposed between the pad P and the bump B. It is understood that the bump B is electrically conductive.

The conductive particles CP contact the pad P and the bump B to electrically connect the pad P with the bump B. The conductive particles CP are formed by coating a particle (e.g., a core), the particle including an organic or inorganic material having a suitable elastic modulus, elastic deformation and resilience, with a metal film. The conductive particle CP may be a substantially spherical shape, or may have an aciform shape. A diameter of the conductive particle CP may be, for example, equal to or less than about 5 μm, about 2 to 4 μm, about 2.8 to 3.4 μm, or about 3.0 to 3.2 μm, but the present invention is not limited thereto. Most of the space between the pad portion PP2 and the integrated circuit chip 400 is filled with an adhesive layer which includes the anisotropic conductive layer 20. Thus, the integrated circuit chip 400 may be bonded to the pad portion PP2 by the adhesive layer.

The second pad electrode PE2 is disposed on the first pad electrode PE1 and is overlapped on the first pad electrode PE1. Accordingly, the conductive particles CP contact an upper second pad electrode PE2, of two pad electrodes PE1 and PE2, of the pad P. The second pad electrode PE2 may be disposed to entirely cover the first pad electrode PE1, and a width W2 of the second pad electrode PE2 may be greater than a width W1 of the first pad electrode PE1. For example, the width W1 of the first pad electrode PE1 may be about 8 μm, and the width W2 of the second pad electrode PE2 may be about 10 μm.

An insulating layer 140 may be disposed between the substrate 110 and the pad P. The insulating layer 140 may be a barrier layer for preventing moisture penetration, a buffer layer, a gate insulating layer for insulating a semiconductor and a gate electrode that are described later, or may be a layer including the barrier layer, buffer layer and/or the gate insulating layer stacked on each other.

An interlayer insulating layer 160 may be disposed between the first pad electrode PE1 and the second pad electrode PE2. A contact hole 86 may be disposed in the interlayer insulating layer 160, and the second pad electrode PE2 may be connected to the first pad electrode PE1 through the contact hole 86. Accordingly, the pad electrodes PE1 and PE2, are overlapped with each other with the interlayer insulating layer 160 therebetween. Each pad P may include two pad electrodes PE1 and PE2 that are connected to each other through one contact hole 86.

The contact hole 86 is formed in a length direction of the pad P. For example, as shown in FIG. 2, the contact hole 86 is formed along a central axis Xp of the length direction of the pad P, along the second direction D2. Accordingly, a surface of the second pad electrode PE2 may include a first portion PE2a and a second portion PE2b, which are respectively disposed at left and right sides of the contact hole 86 or the central axis Xp of the length direction of the pad P. The first portion PE2a and the second portion PE2b may be substantially flat, and the conductive particle CP may be positioned on the first portion PE2a and the second portion PE2b. The first portion PE2a and the second portion PE2b may substantially have the same height in a third direction D3 from the substrate 110.

Although the first portion PE2a and the second portion PE2b may be connected to each other by portions thereof which are disposed in the contact hole 86, first portion PE2a and the second portion PE2b may be spaced apart from each other in the first direction D1 by a predetermined gap G1. The gap G1 may be smaller than the diameter of the conductive particle CP.

A first end of the first pad electrode PE1 may be connected to a wire L, which is connected to a signal line of the display panel 10, and the first pad electrode PE1 may be an extension portion of the wire L. The first pad electrode PE1 may be connected to a wire L that is connected to a pad of the pad portion PP1. In this case, the wire L shown in FIG. 2 may extend from a lower portion of the first pad electrode PE1. Accordingly, a signal inputted to the second pad electrode PE2 may be transmitted to the wire L through the first pad electrode PE1, or, conversely, a signal inputted through the wire L may be transmitted to the second pad electrode PE2 through the first pad electrode PE1.

In an exemplary embodiment of the present invention, the contact hole 86 may be formed to have a relatively narrow width Wh1 to secure widths of the first portion PE2a and the second portion PE2b of the second pad electrode PE2, on which the conductive particle CP may be mounted. For example, the contact hole 86 may be formed to have a width that is equal to or less than about a half of a width W1 of the first pad electrode PE1. As the width Wh1 of the contact hole 86 is narrower, contact resistance and adherence between the first pad electrode PE1 and the second pad electrode PE2 may be reduced. According to a contact characteristic of the first pad electrode PE1 and the second pad electrode PE2, the contact hole 86 may have a width Wh1 that is equal to or greater than about ¼ of the width W1 of the first pad electrode PE1. For example, when the width W1 of the first pad electrode PE1 is about 8 μm, the width Wh1 of the contact hole 86 may be about 2 μm.

The integrated circuit chip 400, disposed on the pad portion PP2 downwardly, may sequentially include a silicon substrate 410, a terminal electrode TE, an insulating layer 430, a seed layer SL, and the bump B. The terminal electrode TE may be an output electrode or an input electrode of the integrated circuit. The integrated circuit chip 400 includes the bump B protruding from the silicon substrate 410 of the terminal electrode TE to electrically connect the terminal electrode TE to the pad P of the pad portion PP2. The seed layer SL, for growing the bump B, for example, by electroplating, is disposed between the terminal electrode TE and the bump B. The seed layer SL is connected to the terminal electrode TE through a contact hole 87. The contact hole 87 passes through the insulating layer 430. The terminal electrode TE, the seed layer SL and the bump B may include a metal or a metal alloy. The insulating layer 430 may include an inorganic material such as a silicon oxide (SiOx) and a silicon nitride (SiNx). The bump B may be formed to be relatively thicker than other layers, and for example, to have a thickness of about 5 to 15 μm or about 8 to 12 μm, but the present invention is not limited thereto.

Because of the contact hole 87, the surface of the bump B may be divided into a first portion Ba and a second portion Bb, which are respectively disposed at left and right sides of the contact hole 87. The first portion Ba and the second portion Bb are substantially flat, and the conductive particles CP may be mounted on them. The first portion Ba and the second portion Bb may have substantially the same height in a direction parallel to the third direction D3 from the silicon substrate 110, and they may be spaced apart from each other in the first direction D1, parallel to a surface of the silicon substrate 110 at a predetermined gap G2.

The gap G2 may be relatively narrow, and for example, the gap G2 may be smaller than the diameter of the conductive particle CP so that the widths of the first portion Ba and the second portion Bb of the bump B can be wide. The contact hole 87 may be formed to have the narrow width Wh2 such that the gap G2 can be narrow, and for example, the contact hole 87 may have a width Wh2 that is equal to or less than about a half of the width W3 of the terminal electrode TE. As the width Wh2 of the contact hole 87 is narrower, the contact hole 87 may have the width Wh2 that is equal to or greater than about ¼ of the width W3 of the terminal electrode TE, according to contact resistance and adherence thereof.

The gap G1, formed in the pad P, may be narrower than the width Wh1 of the contact hole 86, and the gap G2, formed in the bump B, may be narrower than the width Wh2 of the contact hole 87. This is because, as the second pad electrode PE2 and the bump B are formed, the contact holes 86 and 87 may be gradually decreased by the second pad electrode PE2 and the bump B. Accordingly, although the width Wh1 of the contact hole 86 and the width Wh2 of the contact hole 87 may be the same, since the bump B may be formed to be thicker than the second pad electrode PE2 (e.g., about 10 times or more), the gap G2 may be narrower than the gap G1. However, for example, when the width Wh1 is wider than the width Wh2, the gap G2 may be wider than the gap G1, or they may be substantially the same. When the width Wh2 of the contact hole 87 is sufficiently narrow, the bump B may have a substantially flat surface without the gap G2.

In a state in which the integrated circuit chip 400 is bonded to the pad portion PP2 so that the bump B are disposed on the pad P, the first portion Ba, the second portion Bb, and the gap G2 of the bump B may be respectively overlapped with the first portion PE2a, the second portion PE2b, and the gap G1 of the second pad electrode PE2, as shown in FIG. 3.

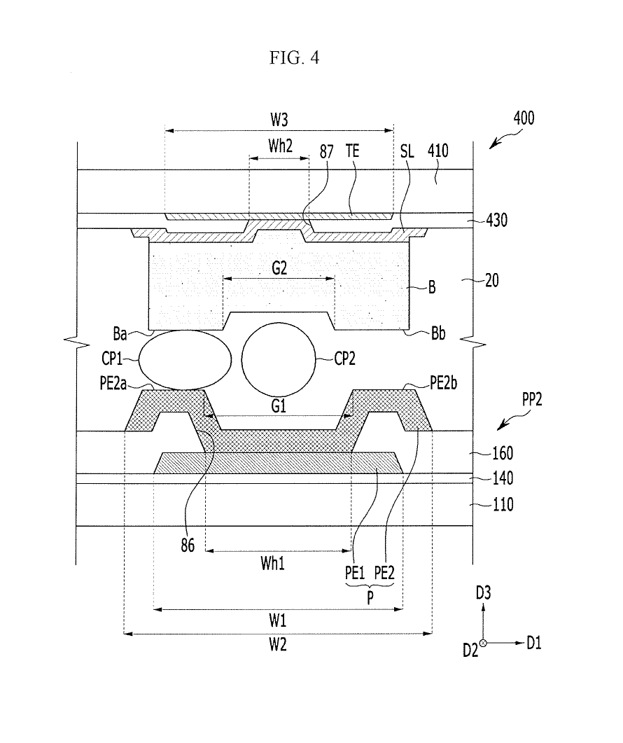

The widths of the first portions (PE2a, Ba) and the second portions (PE2b, Bb), on which the conductive particle CP may be mounted, may be widened by narrowing the width Wh1 of the contact hole 86 of the pad portion PP2 and the width Wh2 of the contact hole 87 of the integrated circuit chip 400. Thus, a capture rate of conductive particles CP, contributing to the electrical connection of the bump B and the pad P, may increase. Such an effect will be further understood by referring to an example described with reference to FIG. 4, in which the contact holes 86 and 87 are formed to be wide.

FIG. 4 is a cross-sectional view illustrating a pad region according to an approach.

For example, FIG. 4 illustrates the cross-section of FIG. 3 with structural changes when compared to cross-section of FIG. 3. For example, the contact hole 86 of FIG. 4 is widely formed in the interlayer insulating layer 160 of the pad portion PP2. Thus, in the surface of the second pad electrode PE2, the widths of the first portion PE2a and the second portion PE2b, on which the conductive particles CP1 and CP2 may be mounted, are narrow, and the gap G1 between the first portion PE2a and the second portion PE2b is wider than the diameters of the conductive particles CP1 and CP2. The contact hole 87 is widely formed in the insulating layer 430 of the integrated circuit chip 400. Thus, in the surface of the bump B, the widths of the first portion Ba and the second portion Bb, on which the conductive particles CP1 and CP2 may be mounted, are narrow, and the gap G2 between the first portion Ba and the second portion Bb is wider than the diameter of the conductive particles CP1 and CP2.

In this case, some conductive particles CP1 may be disposed between the first portion PE2a of the second pad electrode PE2 and the first portion Ba of the bump B, or between the second portion PE2b of the second pad electrode PE2 and the second portion Bb of the bump B to electrically connect the second pad electrode PE2 and the bump B. The other conductive particles CP2 may be disposed inside a space that is defined by the gap G1, formed by the second pad electrode PE2, and the gap G2, formed in the bump B. The second pad electrode PE2 and the bump B are spaced apart from each other in the third direction D3 due to the conductive particle CP1 between the first portions (PE2a, Ba) or the second portions (PE2b, Bb). Thus the conductive particle CP2 disposed between two gaps G1 and G2 does not contact both the second pad electrode PE2 and the bump B, or it fails to contact the second pad electrode PE2 or the bump B. Accordingly, even though the conductive particle CP2 is between the pad P and the bump B, it does not contribute to electrically connect the pad P and the bump B.

Referring back to FIG. 3, since the gap G1, formed in the second pad electrode PE2, according to an exemplary embodiment of the present invention, and the gap G2, formed in the bump B are narrower than the conductive particle CP, the conductive particle CP is not positioned inside a space defined by the gap G1 and the gap G2. Accordingly, since all of the conductive particles CP positioned between the pad P and the bump B may serve as conductive particles, a capture rate of the conductive particles CP may increase.

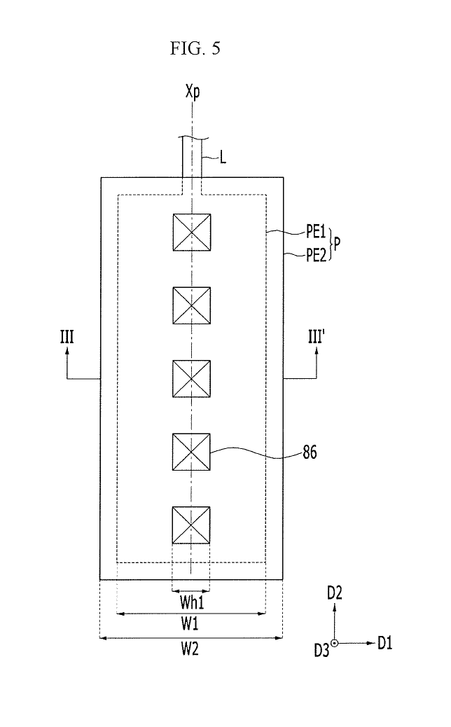

FIG. 5 is a top plan view illustrating a pad of the display device of in FIG. 1, according to an exemplary embodiment of the present invention.

Although one contact hole 86 is disposed along the longitudinal central axis Xp of the length direction of the pad P of FIG. 3, a plurality of contact holes 86 are disposed along the central axis Xp of the length direction of the pad P of FIG. 5. A cross-sectional view taken along line of FIG. 5, illustrating the contact hole 86, may be substantially the same as the cross-sectional view of FIG. 3.

In the case when a plurality of contact holes 86 are formed, an area in which the second pad electrode PE2 contacts a first pad electrode PE1 is reduced, when compared to the case that one contact hole 86 is formed long. Thus, the contact resistance between the first pad electrode PE1 and the second pad electrode PE2 may increase. However, since an area on which the conductive particles CP may be mounted increases as by as much as the area of the contact hole 86 decreases, the capture rate of the conductive particles CP may increase. In FIG. 5, although five contact holes 86 are shown to be disposed at predetermined intervals, the number of contact holes 86 may be more than five or less than five, and a length of each contact hole 86 or a gap between the contact holes 86 may be variously changed. The width Wh1 of the contact hole 86, as described above, may be formed to have a width that is equal to or less than about a half of the width W1 of the first pad electrode PE1, and may be formed to have a width that is equal to or greater than about ¼ of the width W1 of the first pad electrode PE1.

The display device has been described with respect to the pad region in which a driving circuit chip is bonded. Hereinafter, a stacked structure of the display device will be described.

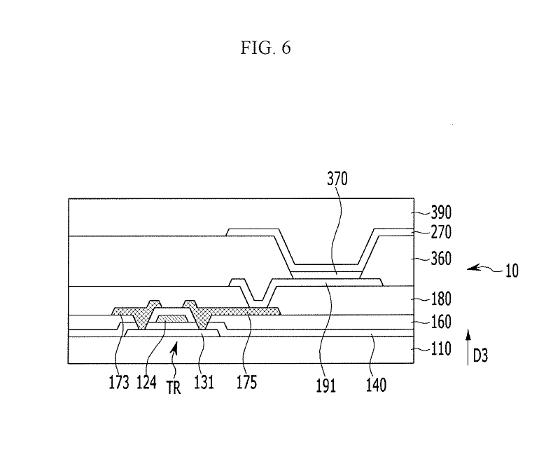

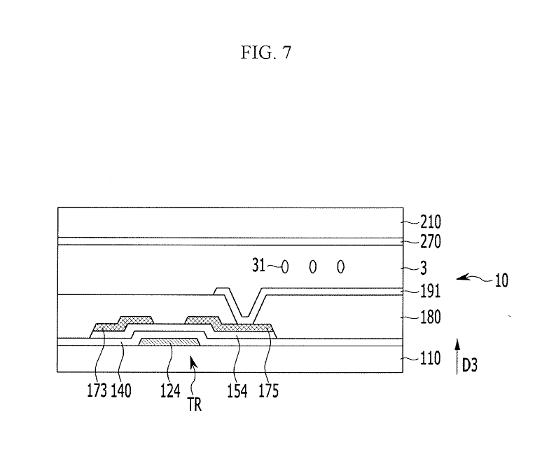

FIG. 6 is a cross-sectional view illustrating a pixel area of the display device of in FIG. 1, according to an exemplary embodiment of the present invention. FIG. 7 is a cross-sectional view illustrating a pixel area of the display device of in FIG. 1, according to an exemplary embodiment of the present invention.

The display device of FIG. 6 may be an organic light emitting device. The display device of FIG. 7 may be a liquid crystal display. The organic light emitting device will be described first, and then the liquid crystal display will be described second. In addition, features associated with the pad region will be described with reference to FIG. 3. It is understood that the pixel area of the display device refers to the display area (DA), in which the pixels PX are disposed.

Referring to FIG. 6, the display panel 10 includes the substrate 110 and a plurality of layers disposed on the substrate 110.

The substrate 110 may be a flexible substrate including a polymer film. For example, the substrate 110 may include a plastic such as polyimide, polyamide, or polyethylene terephthalate. In addition, the substrate 110 may be a rigid substrate including glass.

A barrier layer for preventing diffusion of impurities, which cause degradation of semiconductor characteristics, and moisture penetration may be disposed inside of the substrate 110.

A semiconductor 131 of a transistor TR is disposed on the substrate 110, and the insulating layer 140 is disposed on the semiconductor 131. The semiconductor 131 includes a source region, a drain region and a channel region which is disposed between the source region and the drain region. The semiconductor 131 may include a polysilicon, an oxide semiconductor, or amorphous silicon. The insulating layer 140 may be formed by stacking inorganic materials such as a silicon oxide and a silicon nitride on each other. The insulating layer 140 may include a barrier layer, a buffer layer, and/or a gate insulating layer. The insulating layer 140 may be disposed, for example, only in a region where the insulating layer 140 overlaps the first pad electrode PE1 and a gate conductor such as a gate electrode 124, and the insulating layer 140 might not be disposed at the pad portion PP2. For example, the insulating layer 140 might not be disposed on the second pad electrode PE2.

The gate conductor including the first pad electrode PE1 of the pad P and the gate electrode 124 of the transistor TR are disposed on the insulating layer 140. The first pad electrode PE1 and the gate electrode 124 may be formed together by stacking and patterning conductive materials such as copper (Cu), aluminum (Al), silver (Ag), molybdenum (Mo), chromium (Cr), tantalum (Ta), and/or titanium (Ti) on the substrate 110.

The interlayer insulating layer 160 may be disposed on the first pad electrode PE1 and the gate electrode 124. The interlayer insulating layer 160 may include an inorganic material. A data conductor, including the second pad electrode PE2 of the pad P, a source electrode 173 and a drain electrode 175 of the transistor TR, may be disposed on the interlayer insulating layer 160. The source electrode 173 and the drain electrode 175 are respectively connected to a source region and a drain region of the semiconductor 131 through the contact holes formed in the interlayer insulating layer 160 and the insulating layer 140. The second pad electrode PE2 is connected to the first pad electrode PE1 through the contact hole 86, formed in the interlayer insulating layer 160. The data conductor, for example, may include metals such as copper (Cu), aluminum (Al), silver (Ag), molybdenum (Mo), chromium (Cr), gold (Au), platinum (Pt), palladium (Pd), tantalum (Ta), tungsten (W), titanium (Ti), nickel (Ni), etc., or metal alloys. The data conductor may have a plurality of layers, for example, a triple layer of titanium/aluminum/titanium.

A passivation layer 180 may be disposed on the source electrode 173 and the drain electrode 175. The passivation layer 180 may include an organic material. Although the passivation layer 180 is not disposed on the pad portion PP2, the passivation layer 180 may be disposed between adjacent pads P.

A pixel electrode 191 may be disposed on the passivation layer 180. The pixel electrode 191 may be connected to the drain electrode 175 through a contact hole formed in the passivation layer 180 to receive a data signal.

A pixel defining layer 360 may be disposed on a portion of the passivation layer 180 and the pixel electrode 191. The pixel defining layer 360 has an opening overlapped with the pixel electrode 191. In the opening of the pixel defining layer 360, an emission layer 370 is disposed on the pixel electrode 191, and a common electrode 270 is disposed on the emission layer 370. The pixel electrode 191, the emission layer 370, and the common electrode 270 form an organic light emitting diode. The pixel electrode 191 may be an anode of the organic light emitting diode, and the common electrode 270 may be a cathode of the organic light emitting diode. The common electrode 270 may include a transparent conductive material such as an indium tin oxide (ITO) and/or an indium zinc oxide (IZO). An encapsulation layer 390 for protecting the organic light emitting diode may be disposed on the common electrode 270. The encapsulation 390 may include at one or more organic material layers and/or one or more inorganic material layers. The pixel defining layer 360 and the encapsulation 390 are not disposed on the pad portion PP1 so that the pad P may be exposed.

The integrated circuit chip 400, including the bumps B, may be disposed on the pad portion PP2. The anisotropic conductive layer 20, including the conductive particles CP, is disposed between the pad P and the flexible PCB 50 to bond the integrated circuit chip 400 to the pad portion PP2 and to electrically connect the pad P and the bump B.

Referring to FIG. 7, in a liquid crystal display, the gate electrode 124 of the transistor TR may be disposed on the substrate 110, and the insulating layer 140 may be disposed on the gate electrode 124 of the transistor TR. A semiconductor 154 of the transistor TR may be disposed on the insulating layer 140, and the source electrode 173 and the drain electrode 175 of the transistor TR may be disposed on the semiconductor 154.

The passivation layer 180 may be disposed on the source electrode 173 and the drain electrode 175, and the pixel electrode 191 may be disposed on the passivation layer 180. The pixel electrode 191 may be connected to the drain electrode 175 through the contact hole formed in the passivation layer 180 to receive the data signal.

A liquid crystal layer 3, including liquid crystal molecules 31, may be disposed on the pixel electrode 191, and an insulating layer 210, for sealing the liquid crystal layer 3, may be disposed on the liquid crystal layer 3, with the substrate 110. The insulating layer 210 may have the same shape as, for example, the substrate 110. The liquid crystal layer 3 may be provided to be separated with fine spaces.

The common electrode 270, for generating an electric field to the liquid crystal layer 3, together with the pixel electrode 191 may be provided below the insulating layer 210. The electric field may control a direction in which the liquid crystal molecules 31 are aligned. An alignment layer may be disposed between the pixel electrode 191 and the liquid crystal layer 3 and between the liquid crystal layer 3 and the common electrode 270. In addition, the common electrode 270 may be disposed between the substrate 110 and the liquid crystal layer 3.

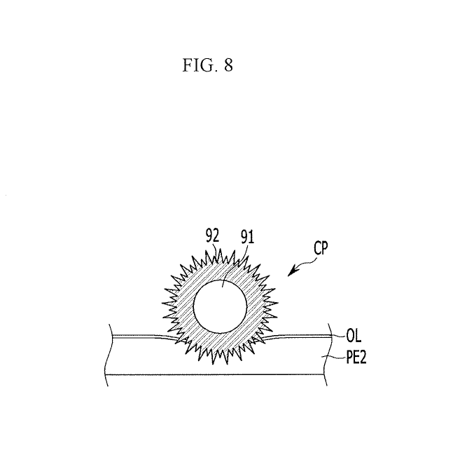

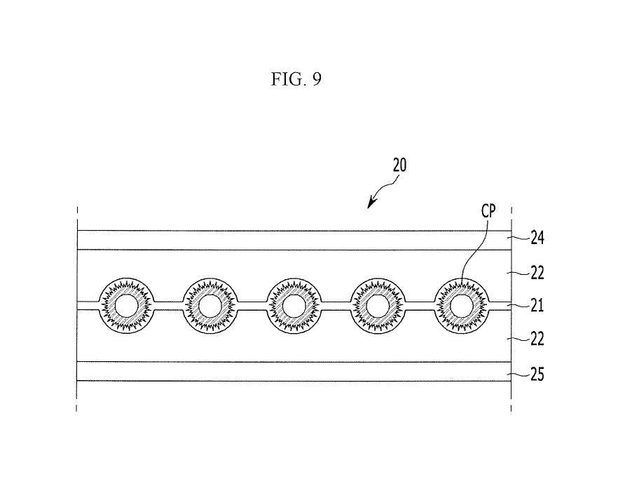

An anisotropic conductive layer and conductive particles that may be used in a display device to increase the capture rate of the conductive particles will be described with reference to FIG. 8 and FIG. 9.

FIG. 8 is a cross-sectional view illustrating a conductive particle according to an exemplary embodiment of the present invention. FIG. 9 is a cross-sectional view illustrating an anisotropic conductive layer of a display device, according to an exemplary embodiment of the present invention.

Referring to FIG. 8, a conductive particle CP is mounted on the second pad electrode PE2 of the pad P. The conductive particle CP has a structure in which aciform projections 92 are provided on a spherical core 91.

The core 91 may include an organic or inorganic material having elastic deformability and resilience, for example, a resin material. For example, the aciform projections 92 may be made by forming projections on a surface of the core 91 with a conductive material such as lead (Pb) and then coating a metal material such as nickel (Ni) thereon. Since the aciform conductive particle CP has a better penetration characteristic than a conductive particle with a smooth surface, the aciform conductive particle CP has an excellent connection to the pad P. A “connection member”, as used throughout this specification, may be, for example, the integrated circuit chip 400. In addition, the “connection member” and the integrated circuit chip 400 may be used interchangeably throughout the specification.

When the integrated circuit chip 400 (e.g., a connection member) is attached to the pad portion PP2 by using the anisotropic conductive layer 20, the integrated circuit chip 400 and the pad portion PP2 may be attached to each other by pressing the bump B of integrated circuit chip 400 against the conductive particles CP, and the conductive particles CP in turn press against the second pad electrode PE2 of the pad P. Then, the adhesive material of the anisotropic conductive layer 20 may be cured by using heat, light, etc. When the aciform conductive particle CP is used as a conductive particle, although a relatively low pressure is applied to the anisotropic conductive layer 20, the aciform conductive particles CP may penetrate an oxide layer OL disposed on the surface of the second pad electrode PE2. Thus, the aciform conductive particles CP may be connected to the second pad electrode PE2.

FIG. 9 illustrates a state before the anisotropic conductive layer 20, including the aciform conductive particles CP shown in FIG. 8, is applied to the display device. The anisotropic conductive layer 20 includes the conductive particles CP suspended in an adhesive layer 22, and the adhesive layer 22 is a resin layer that is not cured. The adhesive layer 22 may be a thermosetting resin layer or a photocurable resin layer. For example, the adhesive layer 22 may be a polymerization resin layer including an epoxy compound or an acrylate compound and a polymerization initiator. The polymerization initiator may be an ion polymerization initiator or a radical polymerization initiator. The adhesive layer 22 may be a thermosetting resin such as epoxy resin, a polyester resin, a bismaleimide resin, a cyanate resin, etc., and the adhesive layer 22 may be in a semi-cured state. Release papers 24 and 25 are disposed on opposite surfaces of the adhesive layer 22. The release papers 24 and 25 are removed when using the anisotropic conductive layer 20. A first surface of the adhesive layer 22 contacts the pad portion of the display panel, and a second surface thereof contacts the connection member.

The conductive particles CP are connected to each other by an insulative nanofiber layer 21. For example, the conductive particles CP are surrounded by the nanofiber layer 21. The portions of the nanofiber layer 21 between the conductive particles CP may have a thickness smaller than the diameter of the conductive particles CP. Although it is illustrated that gaps between the aciform conductive particles CP are constant, the gaps may be irregular.

The anisotropic conductive layer 20 may be formed by jetting a solution in which the conductive particles CP are mixed with a polymer solution through a nozzle and then evaporating a solvent. Polyvinylidene fluoride may be used as a polymer for forming the nanofiber layer 21, but the present invention is not limited thereto. For example, polyimide, polyethylene terephthalate, polycarbonate, polybutylene succinate, polyethylene, etc., may be used as a polymer for forming the nanofiber layer 21.

According to an exemplary embodiment of the present invention, while the connection member is attached to the pad portion through the anisotropic conductive layer 20, although a pressure is applied to the anisotropic conductive layer 20, it may be difficult for the conductive particles CP to move in the adhesive layer 22. For example, when the conductive particle CP between the bump B and the pad P shown in FIG. 3 is pressed, the conductive particle CP may be pushed out from the overlap of the bump B and the pad P. However, since the conductive particles CP, according to an exemplary embodiment of the present invention, are bound to each other by the nanofiber layer 21, movement of the conductive particles CP is limited. Thus, the conductive particle CP are not pushed out from the overlap of the bump B and the pad P. Although the conductive particles CP are surrounded by the nanofiber layer 21, since the conductive particles CP of the aciform shape have the excellent penetration characteristic, and the nanofiber layer 21 surrounding the conductive particles CP may be melted when pressed, the nanofiber layer 21 does not impair the electrical connection capability of the conductive particles CP.

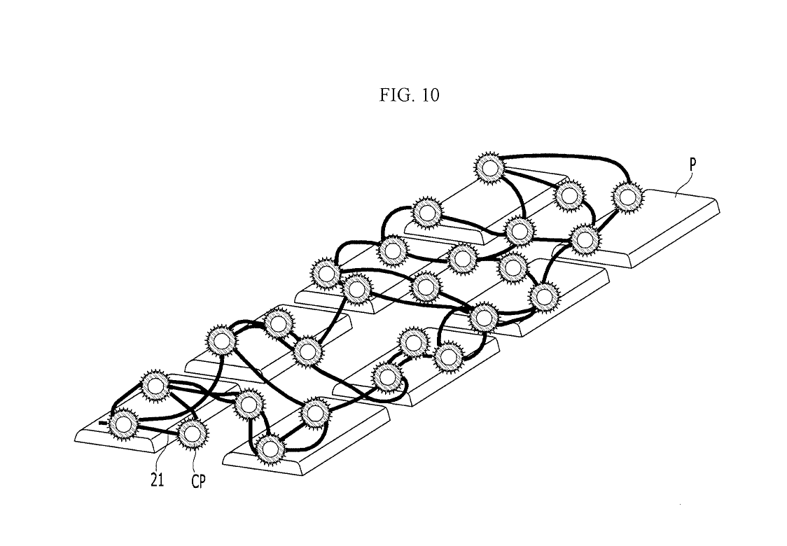

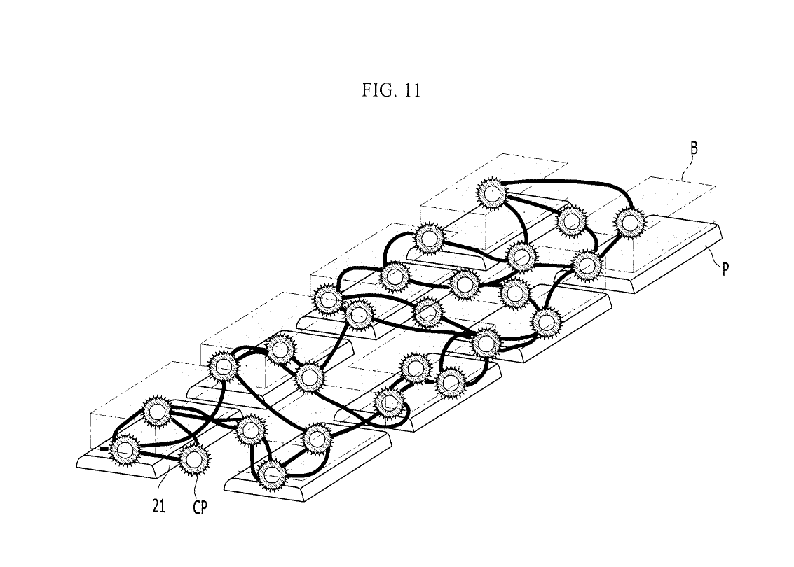

FIG. 10 is a perspective view illustrating a state in which an anisotropic conductive layer is applied to a pad portion of a display device, according to an exemplary embodiment of the present invention. FIG. 11 is a perspective view illustrating a state in which an anisotropic conductive layer and an integrated circuit chip are applied to a pad portion of a display device, according to an exemplary embodiment of the present invention.

In FIG. 10 and FIG. 11, the pads P, the aciform conductive particles CP and the nanofiber layer 21 of the anisotropic conductive layer 20, and the bumps B and the pads P, which are shown as cuboid shapes, are illustrated in a simplified form for clarity.

Referring to FIG. 10, when the anisotropic conductive layer 20 is disposed on the pad portion P, some of the conductive particles CP, connected to each other by the nanofiber layer 21, may be disposed on the pad P, and other conductive particles CP may be disposed between the pads P. Referring to FIG. 11, although the integrated circuit chip 400 is disposed and pressed on the anisotropic conductive layer 20, since the conductive particles CP are bound by the nanofiber layer 21, the conductive particles CP disposed on the pad P do not move between the pads P, and may be held in place. Since the conductive particles CP have the aciform shape, the conductive particles CP may penetrate through the nanofiber layer 21, the oxide layer of the pad P, etc., to electrically connect the bumps B to the pads P. Due to the aciform structure of the conductive particles CP, the conductive particles CP may have excellent penetration characteristic even when subjected to a low pressure. Thus, damage that may occur when the conductive particles CP are pressed may be prevented. Accordingly, the driving circuit chip may be made thinner.

While the present invention has been particularly shown and described with reference to exemplary embodiments thereof, it will be apparent to those of ordinary skill in the art that various changes in form and detail may be made therein without departing from the spirit and scope of the present invention.

What is claimed is:

1. A display device, comprising:
a pad portion disposed on a first substrate;
a connection member disposed on the pad portion; and
an anisotropic conductive layer disposed between the pad portion and the connection member, the anisotropic conductive layer including conductive particles,
wherein the pad portion includes a pad, the pad including a first pad electrode and a second pad electrode, wherein a first insulating layer is disposed between the first pad electrode and the second pad electrode,
wherein the first insulating layer overlaps the first pad electrode, wherein the second pad electrode is connected to the first pad electrode through a first contact hole,
wherein the first contact hole overlaps a center of the first pad electrode, and wherein the first pad electrode is at least twice as wide as the first contact hole.

2. The display device of claim 1, wherein a width of the first contact hole is equal to or greater than about 2 μm.

3. The display device of claim 1, wherein the first insulating layer includes only one contact hole in a region in which the first insulating layer overlaps the first pad electrode.

4. The display device of claim 1, wherein a surface of the second pad electrode includes a first portion and a second portion that are respectively disposed at opposite sides of the first contact hole in a width direction of the pad, and the first and second portions of the second pad electrode are substantially coplanar, and
wherein a first gap between the first portion and the second portion of the second pad electrode is smaller than a diameter of the conductive particles.

5. The display device of claim 4, wherein the diameter of the conductive particles is about 2 to about 4 μm.

6. The display device of claim 1, wherein the connection member includes a second substrate, a terminal electrode disposed on the second substrate, a seed electrode disposed on the terminal electrode, a bump disposed on the seed electrode, and a second insulating layer disposed between the terminal electrode and the seed electrode,
wherein the second insulating layer has a second contact hole overlapping the terminal electrode, wherein the seed electrode is connected to the terminal electrode through the second contact hole, and wherein the terminal electrode is at least twice as wide as the second contact hole.

7. The display device of claim 6, wherein a surface of the bump includes a first portion and a second portion that are respectively disposed at opposite sides of the second contact hole in a width direction of the bump, and the first and second portions of the bump are substantially coplanar, and
wherein a second gap between the first portion and the second portion of the bump is smaller than a diameter of the conductive particles.

8. The display device of claim 1, wherein the conductive particles include aciform conductive particles.

9. The display device of claim 8, wherein each of the aciform conductive particles includes a core and aciform projections disposed on a circumference of the core.

10. The display device of claim 9, wherein the second pad electrode includes an oxide layer, and one or more of the aciform projections of at least one of the conductive particles penetrates through the oxide layer.

11. The display device of claim 8, wherein the anisotropic conductive layer includes a nanofiber layer configured to connect at least two of the conductive particles together.

12. The display device of claim 11, wherein the nanofiber layer surrounds the at least two of the conductive particles.

13. The display device of claim 11, wherein the nanofiber layer includes polyvinylidene fluoride.

14. The display device of claim 1, wherein the connection member is an integrated circuit chip.

15. A display device, comprising:
a pad portion disposed on a first substrate;
a connection member disposed on the pad portion; and
an anisotropic conductive layer disposed between the pad portion and the connection member, wherein the anisotropic conductive layer includes conductive particles,
wherein the pad portion includes a pad, the pad including a first pad electrode and a second pad electrode, and a first insulating layer is disposed between the first pad electrode and the second pad electrode,
wherein the first insulating layer overlaps the first pad electrode, and the second pad electrode is connected to the first pad electrode through a first contact hole,
wherein a surface of the second pad electrode includes a first portion and a second portion that are respectively disposed at opposite sides of the first contact hole in a width direction of the pad, wherein the first and second portions of the surface of the second pad electrode are substantially coplanar, and
wherein a gap between the first portion and the second portion of the surface of the second pad electrode is smaller than a diameter of the conductive particles.

16. The display device of claim 15, wherein the diameter of the conductive particles is about 2 to about 4 μm.

17. The display device of claim 15, wherein the first contact hole overlaps a center of the first pad electrode, and the first pad electrode is at least twice as wide as the first contact hole.

18. The display device of claim 17, wherein the width of the first contact hole is equal to or greater than about 2 μm.

19. The display device of claim 15, wherein the first insulating layer includes only one contact hole in a region in which the first insulating layer overlaps the first pad electrode.

20. The display device of claim 15, wherein the connection member includes a second substrate, a terminal electrode disposed on the second substrate, a seed electrode disposed on the terminal electrode, a bump disposed on the seed electrode, and a second insulating layer disposed between the terminal electrode and the seed electrode,
wherein the second insulating layer has a second contact hole overlapping the terminal electrode, wherein the seed electrode is connected to the terminal electrode through the second contact hole, and
wherein the terminal electrode is at least twice as wide as the second contact hole.
